(19) United States
(12) Patent Application Publication
(10) Pub. No.: US 2026/0163249 A1
(43) Pub. Date: Jun. 11, 2026

(54) NEXTG-RECONFIGURABLE LOW-POWER MMWAVE METASURFACE

(71) Applicant: Korea Advanced Institute of Science and Technology, Daejeon (KR)

(72) Inventors: Song Min KIM, Daejeon (KR); Namjo AHN, Daejeon (KR); MinSeok KIM, Daejeon (KR)

(73) Assignee: Korea Advanced Institute of Science and Technology, Daejeon (KR)

(21) Appl. No.: 19/395,799

(22) Filed: Nov. 20, 2025

(30) Foreign Application Priority Data
Dec. 5, 2024 (KR) 10-2024-0179490

(51) Int. Cl. H01Q 15/00; H01Q 15/14

(52) U.S. Cl. CPC H01Q 15/0086; H01Q 15/14

(57) ABSTRACT

Provided is a 5G mobile communication-based low-power millimeter wave (mmWave) metasurface. The low-power mmWave metasurface may include a plurality of unit cells that operate in the mmWave band, and each of the unit cells may include a substrate; a reflector on the substrate; and a phase shifter connected to the reflector on the substrate, and configured to shift a phase of a mmWave signal incident to the reflector, including a plurality of varactor diodes.

### CROSS-REFERENCE TO RELATED APPLICATION(S)

This application claims the priority benefit of Korean Patent Application No. 10-2024-0179490, filed on Dec. 5, 2024, in the Korean Intellectual Property Office, the disclosure of which is incorporated herein by reference.

### BACKGROUND

### 1. Field of the Invention

Example embodiments of the present disclosure relate to a 5-th generation (5G) mobile communication-based low-power millimeter wave (mmWave) metasurface.

### 2. Description of the Related Art

With the launch of new 5-th generation (5G) (new radio (NR)) mobile communication in 2019, a millimeter wave (mmWave) communication service (FR2) also appeared. Unlike the existing frequency band lower than 6 GHz, the wide bandwidth of mmWave was expected to be key technology for achieving low latency and high communication speeds. However, due to unfavorable propagation characteristics against mmWave band communication, such as high signal attenuation, low penetration, and narrow coverage, installation of base stations that are more than 10 times denser than existing 4G base stations is required. Therefore, to date, there is no telecommunications service provider that provides services through actual commercialization of the mmWave band due to high initial cost and expensive maintenance cost.

Therefore, metasurface that may be operated at low power and low cost is in the spotlight to reduce maintenance cost and to improve practicality of mmWave. The metasurface has the characteristic that power consumption is very small since the metasurface reflects a signal from a base station rather than directly generating and transmitting a signal. Also, it is technology that may overcome the limitations of low coverage of the base station due to its distribution at low cost.

The metasurface refers to the surface having reflection/transmission properties that are absent in nature, and may directly change a channel environment by adjusting reflection/penetration of signals. Metasurface technology has the potential to directly control a channel environment and to form a signal path with strong signal intensity. However, conventional metasurface technology has the limited compatibility with mobile communication mmWave systems and has a high cost issue in terms of deployment and control.

### SUMMARY

The present disclosure relates to a 5-th generation (5G) mobile communication-based low-power millimeter wave (mmWave) metasurface.

According to the present disclosure, a low-power mmWave metasurface may include a plurality of unit cells that operate in the mmWave band, wherein each of the unit cells includes a substrate; a reflector on the substrate; and a phase shifter connected to the reflector on the substrate, and configured to shift a phase of a mmWave signal incident to the reflector, including a plurality of varactor diodes.

According to the present disclosure, a communication relay device having a low-power mmWave metasurface may include a metasurface including a plurality of unit cells that operate in the mmWave band; and a controller configured to control the metasurface, wherein each of the unit cells includes a substrate; a reflector on the substrate; and a phase shifter connected to the reflector on the substrate, and configured to shift a phase of a mmWave signal incident to the reflector, including a plurality of varactor diodes, and the controller is configured to change the capacitance of the varactor diodes by applying a bias voltage to each of the unit cells.

According to the present disclosure, in an operating method of a communication relay device having a low-power mmWave metasurface, the metasurface may include a plurality of unit cells that operate in the mmWave band, and each of the unit cells may include a substrate; a reflector on the substrate; and a phase shifter connected to the reflector on the substrate, and configured to shift a phase of a mmWave signal incident to the reflector, including a plurality of varactor diodes, and the operating method of the communication relay device may include changing the capacitance of the varactor diodes by applying a bias voltage to each of the unit cells.

According to the present disclosure, a metasurface that operates in mmWave assigned to 5G mobile communication may be implemented. Here, a low-power continuous-phase controllable metasurface may be implemented through varactor diode-based phase shift design. Specifically, when configuring the metasurface using a plurality of unit cells, it is possible to increase the degree of phase shift freedom with a relatively small number of varactor diodes, thereby enabling the metasurface to operate at ultra low power. Also, it is possible to perform continuous phase control for each of unit cells based on the characteristic that the capacitance continuously varies according to an input voltage of varactor diodes. Also, the use of a relatively small number of varactor diodes may lead to reduction in the metasurface manufacturing cost. As a result, the present disclosure may achieve the metasurface with high compatibility with 5G mobile communication mmWave systems, and low deployment and control cost. Therefore, through the metasurface of the present disclosure, it is possible to improve the unfavorable propagation characteristics of the mmWave band and to expand its coverage at low cost.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a low-power millimeter wave (mmWave) metasurface according to various example embodiments;

FIG. 2 illustrates a unit cell of a low-power mmWave metasurface according to various example embodiments;

FIG. 3 illustrates S11 simulation results of a phase shifter of FIG. 2;

FIG. 4 illustrates a communication relay device having a low-power mmWave metasurface according to various example embodiments;

FIG. 5 illustrates reinforcement interference/offset interference pattern simulation results of a low-power mmWave metasurface according to various example embodiments; and

FIG. 6 illustrates an operating method of a communication relay device having a low-power mmWave metasurface according to various example embodiments.

### DETAILED DESCRIPTION

Hereinafter, various example embodiments of the disclosure will be described with reference to the accompanying drawings.

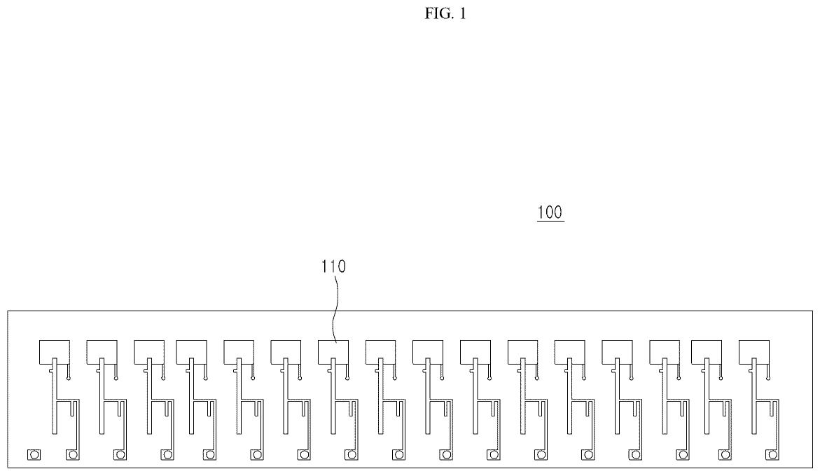

FIG. 1 illustrates a low-power millimeter wave (mmWave) metasurface 100 according to various example embodiments.

Referring to FIG. 1, the metasurface 100 may include a plurality of unit cells 110 that operate in the mmWave band. Each of the unit cells 110 may shift and reflect the phase of an incident mmWave signal. On the metasurface 100, the unit cells 110 may be configured as a one-dimensional (1D) array or a two-dimensional (2D) array. For example, the unit cells 110 may be configured as a 1D array as shown in FIG. 1. Here, although an example in which 16 unit cells 110 are arranged is illustrated, the present disclosure is not limited thereto. That is, on the metasurface 110, various numbers of unit cells 110 may be configured as a 1D array or a 2D array. Through this arrangement, mmWave signals reflected from the unit cells 110 may be superimposed with different phases. Here, at least one of constructive interference and destructive interference may be formed depending on the respective reflection angles.

Since reflection angles having the maximum constructive interference are determined based on phase shifts of the unit cells 110, the degree of phase shift freedom of unit cells 110 needs to be increased. Meanwhile, the phase shifts of the unit cells 110 may be electrically controlled for fast response speed and scalability. Here, a phase shift design for the unit cells 110 may include a PIN diode-based design and a varactor diode-based design. Both designs may acquire a 360-degree phase shift.

However, the PIN diode-based design requires a large number of PIN diodes to increase the degree of freedom of phase shift due to characteristics of the PIN diode having discrete on/off operations. The degree of freedom may be limited in the mmWave band in which the size of the unit cells 110 inevitably decreases. Also, the PIN diode has extremely high power consumption compared to the varactor diode. In this aspect, the PIN diode may be unsuitable for use in the metasurface 100 that includes a large number of unit cells 110.

Meanwhile, since the varactor diode has the characteristic that capacitance continuously varies according to an input voltage, the varactor diode-based design may increase the degree of freedom of phase shift even with a small number of varactor diodes. Also, since the varactor diode only has power consumption in units of nano power (nW) due to leakage current of a capacitor, even the metasurface 100 configured with a large number of unit cells 110 may operate at ultra-low power.

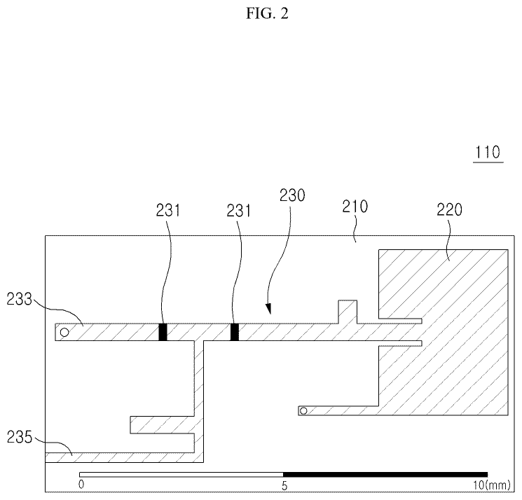

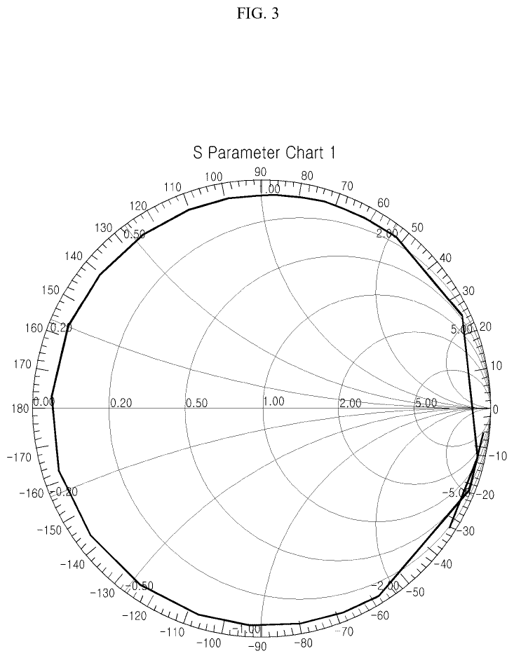

FIG. 2 illustrates the unit cell 110 of the low-power mmWave metasurface 100 according to various example embodiments. FIG. 3 shows S11 simulation results of a phase shifter 230 of FIG. 2.

Referring to FIG. 2, the unit cell 110 is implemented to enable a 360-degree phase shift, and may include a substrate 210, a reflector 220, and the phase shifter 230.

The substrate 210 may support the reflector 220 and the phase shifter 230. Here, the substrate 210 may have planar dimensions for accommodating the reflector 220 and the phase shifter 230, that is, may have the width, the height, and the thickness (e.g., 8 mm). For example, the substrate 210 may be made of a dielectric material.

The reflector 220 may reflect an incident mmWave signal. The reflector 220 may be disposed on the substrate 210. The reflector 220 may be implemented in various shapes. Here, although an example in which the reflector 220 is implemented in a roughly rectangular shape, the present disclosure is not limited thereto. For example, the reflector 220 may be made of a conductive material.

The phase shifter 230 may shift a phase of a mmWave signal incident to the reflector 220. The phase shifter 230 may be disposed on the substrate 210 and connected to the reflector 220. The phase shifter 230 may include a plurality of varactor diodes 231, a transmission line 233, and a bias line 235.

The varactor diodes 231 have the characteristic that capacitance continuously varies according to an input bias voltage and thus, may enable the phase shift of the mmWave signal incident to the reflector 220. Specifically, two varactor diodes 231 may be provided within the transmission line 233. The varactor diodes 231 may operate in the mmWave band, and may have low capacitance (e.g., 0.04 pF to 0.22 pF).

The transmission line 233 may connect the varactor diodes 231 to the reflector 220. The transmission line 233 may extend from the reflector 220 across the varactor diodes 231. This allows the varactor diodes 231 to be disposed within the transmission line 233. For example, the transmission line 233 may be made of a conductive material.

Here, the length of the transmission line 233 and an interval between the varactor diodes 231 may be determined to maximize the final phase shift according to the combination of phase shifts of the varactor diodes 231. In some example embodiments, the varactor diodes 231 may be spaced apart from each other at an interval of ¼ wavelength of the mmWave signal within the transmission line 233. In some example embodiments, the varactor diodes 231 may include the first varactor diode 231 adjacent to the first reflector 220 and the second varactor diode 231 separate far from the reflector 220. The first varactor diode 231 may be disposed at an interval of ½ wavelength of the mmWave signal from one end of the transmission line 233 adjacent to the reflector 220, and the second varactor diode 231 may be disposed at an interval of ⅝ wavelength of the mmWave signal from the other end, that is, free end of the transmission line 233.

The bias line 235 may be used to apply a bias voltage to the varactor diodes 231. The bias line 235 may be connected to the transmission line 233 between the varactor diodes 231. Through this, a common electrode may be defined at a connection point of the transmission line 233 and the bias line 235, and each of the varactor diodes 231 may be electrically connected to the common electrode. For example, the bias line 235 may be made of a conductive material.

According to various example embodiments, the phase shifter 230 may support a continuous phase change of 360 degrees as shown in FIG. 3. Through this, the phase shifter 230 may achieve free continuous phase control with respect to the reflector 220.

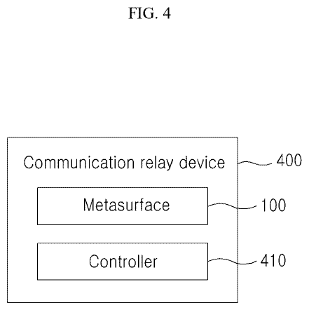

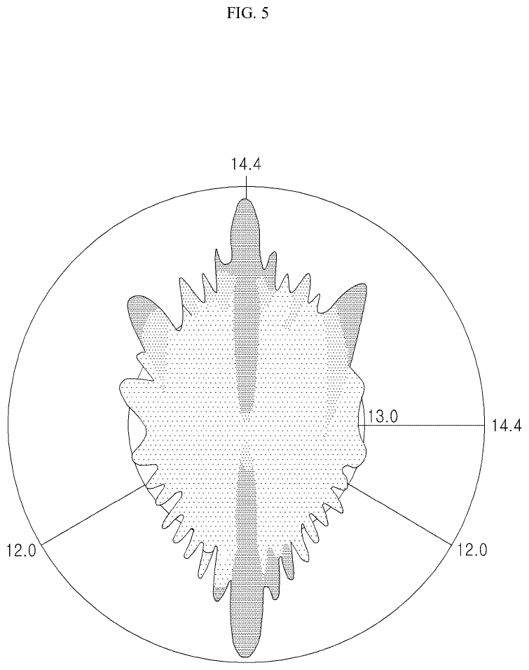

FIG. 4 is a diagram illustrating a communication relay device 400 having the low-power mmWave metasurface 100 according to various example embodiments. FIG. 5 illustrates simulation results of constructive interference/destructive interference patterns of the low-power mmWave metasurface 100 according to various example embodiments.

Referring to FIG. 4, the communication relay device 400 may include the metasurface 100 and a controller 410. As described above, the metasurface 100 may include the plurality of unit cells 110. The controller 410 may control the metasurface 100. Specifically, the controller 410 may cause constructive interference of mmWave signals at desired reflection angles through the optimal phase shift of each of the unit cells 110. For example, as illustrated in FIG. 1, when the unit cells 110 are configured as a 1D array, the unit cells 110, that is, the reflectors 220 of the unit cells 110 may be arranged at an interval of ½ wavelength of mmWave signal. Here, in consideration of reflection angles (θ), a change amount in phase between the adjacent unit cells 110 may be set to occur by 180·sinθ. Through this, constructive interference may be formed at reflection angles ranging from −90 degrees to 90 degrees for mmWave signals incident in any direction.

To this end, the controller 410 may control each of the unit cells 110 with an independent bias voltage. Here, the controller 410 may change capacitance of the varactor diodes 231 by applying a bias voltage to each of the unit cells 110 through the bias line 235. For example, the controller 410 may apply a continuous bias voltage of 0 V to 17 V to change the capacitance of the varactor diodes 231.

According to various example embodiments, the metasurface 100 may form various constructive interference/destructive interference patterns. Here, as illustrated in FIG. 5, the metasurface 100 may form constructive interference at any angle, such as forming a pattern having constructive interference at a specific angle (e.g., −30 degrees and 30 degrees).

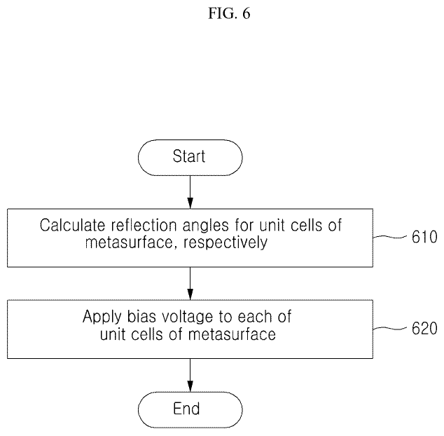

FIG. 6 is a flowchart illustrating an operating method of the communication relay device 400 having the low-power mmWave metasurface 100 according to various example embodiments.

Referring to FIG. 6, in operation 610, the controller 410 may calculate reflection angles for the unit cells 110 of the metasurface 100, respectively. The controller 410 may calculate reflection angles having the maximum constructive interference achievable through the optimal phase shift of each of the unit cells 110.

In operation 620, the controller 410 may apply a bias voltage to each of the unit cells 110 of the metasurface 100. The controller 410 may apply a bias voltage to each of the unit cells 110 such that the unit cells 110 reflect and thereby output mmWave signals incident at the calculated reflection angles. That is, the controller 410 may apply a bias voltage to each of the unit cells such that each of the unit cells 110 performs the optimal phase shift. Specifically, the controller 410 may control each of the unit cells 110 with an independent bias voltage. Here, the controller 410 may change capacitance of the varactor diodes 231 by applying the bias voltage to each of the unit cells 110 through the bias line 235. For example, the controller 410 may apply a continuous bias voltage of 0 V to 17 V to change the capacitance of the varactor diodes 231. Through this, mmWave signals from the unit cells 110 may form the maximum constructive interference.

As described above, the present disclosure may propose the metasurface 100 that may perform low power continuous-phase control, operating in the mmWave band assigned to 5G mobile communication. The present disclosure may propose a method that may form the low power phase shifter 230 based on the varactor diode 231 for achieving continuous-phase control, and may utilize the same to form a constructive interference pattern in an arbitrary direction. In a 5G mobile communication operating environment, a signal-to-noise ratio (SNR) increase of 10 dB or more is possible through the operation of the metasurface 100, and it is possible to enhance unfavorable propagation characteristics of the mmWave band and to expand coverage at low cost.

In summary, the present disclosure provides the low-power mmWave metasurface 100 based on 5G mobile communication.

According to the present disclosure, the low-power mmWave metasurface 100 may include the plurality of unit cells 110 that operates in the mmWave band, and each of the unit cells 110 may include the substrate 210, the reflector 220 on the substrate 210, and the phase shifter 230 connected to the reflector 220 on the substrate 210, and configured to shift a phase of a mmWave signal incident to the reflector 220, including the plurality of varactor diodes 231.

According to the present disclosure, the phase shifter 230 may include two varactor diodes 231.

According to the present disclosure, the phase shifter 230 may further include the transmission line 233 that extends from the reflector 220 and to which the varactor diodes 231 are provided.

According to the present disclosure, the varactor diodes 231 may be spaced apart from each other at an interval of ¼ wavelength of the mmWave signal.

According to the present disclosure, the varactor diodes 231 may include the first varactor diode 231 disposed at an interval of ½ wavelength of the mmWave signal from one end of the transmission line 233 adjacent to the reflector 220, and the second varactor diode 231 disposed at an interval of ⅝ wavelength of the mmWave signal from the other end of the transmission line 233.

The phase shifter 230 may further include the bias line 235 that is connected to the transmission line 233 between the varactor diodes 231, and used to apply a bias voltage to the varactor diodes 231.

According to the present disclosure, the communication relay device 400 having the low-power mmWave metasurface 100 may include the metasurface 100 including the plurality of unit cells 110 that operate in the mmWave band, and the controller 410 configured to control the metasurface 100, and each of the unit cells 110 may include the substrate 210, the reflector 220 on the substrate 210, and the phase shifter 230 connected to the reflector 220 on the substrate 210, and configured to shift a phase of a mmWave signal incident to the reflector 220, including the plurality of varactor diodes 231, and the controller 410 may be configured to change the capacitance of the varactor diodes 231 by applying a bias voltage to each of the unit cells 110.

According to the present disclosure, the phase shifter 230 may include two varactor diodes 231, the transmission line 233 that extends from the reflector 220 and to which the varactor diodes 231 are provided, and the bias line 235 that is connected to the transmission line 233 between the varactor diodes 231, and used to apply a bias voltage to the varactor diodes 231.

According to the present disclosure, the controller 410 may be configured to apply the bias voltage to each of the unit cells 110 through the bias line 235.

According to the present disclosure, in an operating method of the communication relay device 400 having the low-power mmWave metasurface 100, the metasurface 100 may include the plurality of unit cells 110 that operate in the mmWave band, and each of the unit cells 110 may include the substrate 210, the reflector 220 on the substrate 210, and the phase shifter 230 connected to the reflector 220 on the substrate 210, and configured to shift a phase of a mmWave signal incident to the reflector 220, including the plurality of varactor diodes 231, and the operating method of the communication relay device 400 may include changing the capacitance of the varactor diodes 231 by applying a bias voltage to each of the unit cells 110.

According to the present disclosure, the phase shifter 230 may include two varactor diodes 231, the transmission line 233 that extends from the reflector 220 and to which the varactor diodes 231 are provided, and the bias line 235 that is connected to the transmission line 233 between the varactor diodes 231, and used to apply a bias voltage to the varactor diodes 231.

According to the present disclosure, the changing of the capacitance of the varactor diodes 231 by applying the bias voltage to each of the unit cells 110 may include applying the bias voltage to each of the unit cells 110 through the bias line 235.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of recording methods or storage methods in which a single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. A low-power millimeter wave (mmWave) metasurface comprising:
a plurality of unit cells that operate in the mmWave band,
wherein each of the unit cells includes:
a substrate;
a reflector on the substrate; and
a phase shifter connected to the reflector on the substrate, and configured to shift a phase of a mmWave signal incident to the reflector, including a plurality of varactor diodes.

2. The metasurface of claim 1, wherein the phase shifter includes two varactor diodes.

3. The metasurface of claim 2, wherein the phase shifter further includes a transmission line that extends from the reflector and to which the varactor diodes are provided.

4. The metasurface of claim 2, wherein the varactor diodes are spaced apart from each other at an interval of ¼ wavelength of the mmWave signal.

5. The metasurface of claim 3, wherein the varactor diodes includes a first varactor diode disposed at an interval of ½ wavelength of the mmWave signal from one end of the transmission line adjacent to the reflector and a second varactor diode disposed at an interval of ⅝ wavelength of the mmWave signal from the other end of the transmission line.

6. The metasurface of claim 3, wherein the phase shifter further includes a bias line that is connected to the transmission line between the varactor diodes, and used to apply a bias voltage to the varactor diodes.

7. A communication relay device having a low-power millimeter wave (mmWave) metasurface, the communication relay device comprising:
a metasurface comprising a plurality of unit cells that operate in the mmWave band; and
a controller configured to control the metasurface,
wherein each of the unit cells includes:
a substrate;
a reflector on the substrate; and
a phase shifter connected to the reflector on the substrate, and configured to shift a phase of a mmWave signal incident to the reflector, including a plurality of varactor diodes, and
the controller is configured to change the capacitance of the varactor diodes by applying a bias voltage to each of the unit cells.

8. The communication relay device of claim 7, wherein the phase shifter includes:
two varactor diodes;
a transmission line that extends from the reflector and to which the varactor diodes are provided; and
a bias line that is connected to the transmission line between the varactor diodes, and used to apply a bias voltage to the varactor diodes, and
the controller is configured to apply the bias voltage to each of the unit cells through the bias line.

9. An operating method of a communication relay device having a low-power millimeter wave (mmWave) metasurface, wherein the metasurface comprises a plurality of unit cells that operate in the mmWave band, and
each of the unit cells includes:
a substrate;
a reflector on the substrate; and
a phase shifter connected to the reflector on the substrate, and configured to shift a phase of a mmWave signal incident to the reflector, including a plurality of varactor diodes, and
the operating method of the communication relay device comprises changing the capacitance of the varactor diodes by applying a bias voltage to each of the unit cells.

10. The method of claim 9, wherein the phase shifter includes:
two varactor diodes;
a transmission line that extends from the reflector and to which the varactor diodes are provided; and
a bias line that is connected to the transmission line between the varactor diodes, and used to apply a bias voltage to the varactor diodes, and
the changing of the capacitance of the varactor diodes by applying the bias voltage to each of the unit cells comprises applying the bias voltage to each of the unit cells through the bias line.
